(19) United States
(12) Patent Application Publication
(10) Pub. No.: US 2022/0171581 A1
(43) Pub. Date: Jun. 2, 2022

(54) COLOR CONVERSION TABLE GENERATION DEVICE AND RECORDING MEDIUM

(71) Applicant: KONICA MINOLTA, INC., Tokyo (JP)

(72) Inventor: Takeshi YAMAGUCHI, Tokyo (JP)

(73) Assignee: KONICA MINOLTA, INC., Tokyo (JP)

(21) Appl. No.: 17/524,902

(22) Filed: Nov. 12, 2021

(30) Foreign Application Priority Data
Dec. 2, 2020 (JP) 2020-199968

(51) Int. Cl. G06F 3/12

(52) U.S. Cl. CPC G06F 3/1208; G06F 3/125; G06F 3/1256

(57) ABSTRACT

A color conversion table generation device includes a color conversion table acquisition unit, an image data acquisition unit, a read image data acquisition unit, an acceptance unit, and a modification unit. The color conversion table acquisition unit acquires a color conversion table used in color conversion for image data to be printed which is imposed. The image data acquisition unit acquires the image data to be printed. The read image data acquisition unit acquires read image data of a print target corresponding to a partial area in the image data to be printed. The acceptance unit accepts specification of a target area in the image data to be printed which is to be used for modifying the color conversion table. The modification unit modifies the color conversion table based on the read image data and information corresponding to the specified target area.

### BACKGROUND

### 1. Technical Field

The present invention relates to a color conversion table generation device and a recording medium.

### 2. Background Art

In general, image data represented in the CMYK and RGB color systems are dependent on input/output characteristics of input/output devices. When one CMYK image data is printed by different printers, it is reproduced in different colors by the printers. It is necessary to perform color conversion processing on image data which is a source document that will be printed by a printer (image data to be printed) to achieve target color reproduction characteristics. Specifically, a color conversion table used for color conversion of image data to be printed is modified based on correspondence between the image data to be printed and read image data obtained by scanning a print target (color sample). The color conversion table is used for CMYK-L*a*b* conversion and CMYK-CMYK conversion of ICC profile.

For example, in a device that performs color matching by comparing a document image data with read image data of a printed sheet, an area to be read in a large-sized printed sheet is set based on a feature amount detected from the document image data. A set position of the printed sheet in a scanner is displayed based on setting result of the area to be read. Then the printed sheet set in the scanner is read (JP 2016-72816A).

However, in a case where a print target used for color matching is cut, it is difficult to match a position of the cut print target with a position of the image data to be printed. It is a problem. For example, in a case where a partial area of image data to be printed in which the same or similar images are imposed is used for color matching with a print target, it is necessary to fix a position of an area in the image data to be printed which is used for color matching.

### SUMMARY OF INVENTION

The present invention was made in view of the above problems in the prior art. The present invention concerns color conversion that matches colors of a print result of image data to be printed with colors of a print target. An object of the present invention is to easily match colors in a case where a cut print target is used.

To achieve at least one of the above-mentioned objects, according to an aspect of the present invention, a color conversion table generation device includes:

a color conversion table acquisition unit that acquires a color conversion table used in color conversion for image data to be printed which is imposed;

an image data acquisition unit that acquires the image data to be printed;

a read image data acquisition unit that acquires read image data of a print target corresponding to a partial area in the image data to be printed;

an acceptance unit that accepts specification of a target area in the image data to be printed which is to be used for modifying the color conversion table; and

a modification unit that modifies the color conversion table based on the read image data and information corresponding to the specified target area in the image data to be printed.

According to another aspect of the present invention, a non-transitory recording medium stores a computer readable program that causes a computer to function as:

a color conversion table acquisition unit that acquires a color conversion table used in color conversion for image data to be printed which is imposed;

an image data acquisition unit that acquires the image data to be printed;

a read image data acquisition unit that acquires read image data of a print target corresponding to a partial area in the image data to be printed;

an acceptance unit that accepts specification of a target area in the image data to be printed which is to be used for modifying the color conversion table; and

a modification unit that modifies the color conversion table based on the read image data and information corresponding to the specified target area in the image data to be printed.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a system configuration diagram of a print system according to a first embodiment of the present invention.

FIG. 2 is a block diagram showing a functional configuration of a controller.

FIG. 3 is a block diagram showing a functional configuration of a color conversion table generation device.

FIG. 4 is an image that illustrates modification of a color conversion table.

FIG. 5 is a flowchart showing color conversion table modification processing.

FIG. 6 is a flowchart showing imposition job determination processing.

FIG. 7 is a flowchart showing color matching area determination processing.

FIG. 8 is an example of a color matching area specification screen.

FIG. 9 shows data structure of modification amounts for a source profile.

FIG. 10 is a flowchart showing second imposition job determination processing according to a second embodiment.

### DESCRIPTION OF EMBODIMENTS

Hereinafter, embodiments of the present invention will be described in detail with reference to the drawings. The scope of the invention is not limited to the disclosed embodiments.

### First Embodiment

First, a configuration of a print system 100 according to a first embodiment of the present invention will be described.

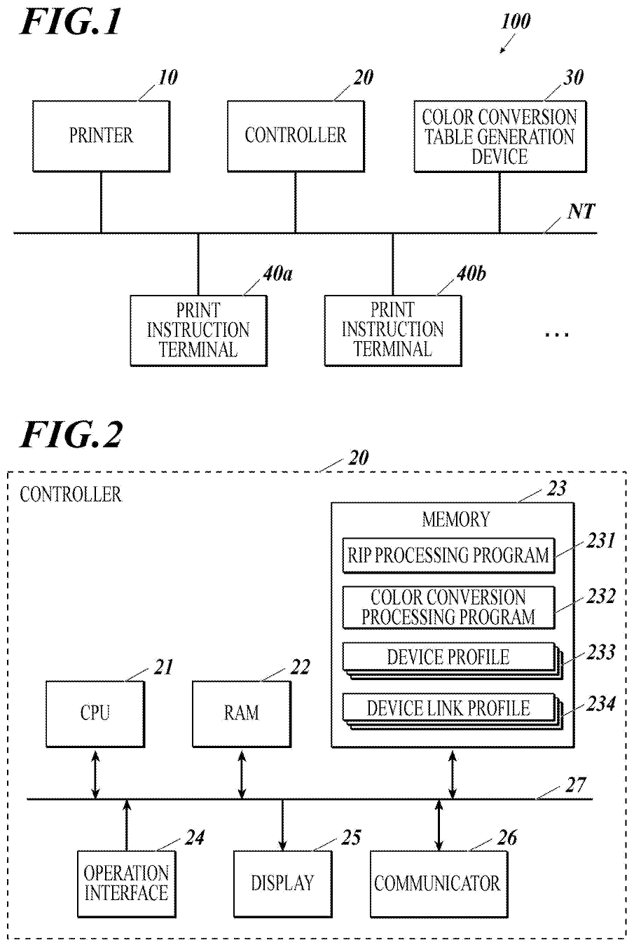

FIG. 1 shows a system configuration of the print system 100. As shown in FIG. 1, the print system 100 includes a printer 10, a controller 20, a color conversion table generation device 30, and print instruction terminals 40a, 40b, etc. Those devices are connected via a communication network NT to enable data communication.

The printer 10 is an image forming device that performs printing based on image data (CMYK data) in a bitmap format received from the controller 20. Various print methods such as an electrophotographic method or an inkjet method can be applied as a print method in the printer 10.

The controller 20 performs rasterization (RIP (raster image processor) processing) on print data transmitted from the print instruction terminals 40a, 40b, etc. The controller 20 generates image data to be printed. The controller 20 performs image processing, such as color conversion and screening, on the image data to be printed and transmits it to the printer 10. The controller 20 may be built into the printer 10. The controller 20 and the printer 10 may be connected via a dedicated line, such as PCI connection.

The color conversion table generation device 30 modifies a color conversion table based on a print target (color sample) which is a target for color matching. The color conversion table is used by the controller 20 to perform color conversion processing on image data to be printed. The color conversion table generation device 30 may be built into the controller 20 or the printer 10.

The print instruction terminals 40a, 40b, etc. give print instructions to the controller 20 using a printer driver program or dedicated software. Specifically, the print instruction terminals 40a, 40b, etc. generate print data as job information in response to user operation. The print instruction terminals 40a, 40b, etc. transmit the generated print data to the controller 20. The print data is described in a page description language (PDL) that can be understood by the controller 20.

FIG. 2 shows a functional configuration of the controller 20. As shown in FIG. 2, the controller 20 includes a CPU (central processing unit) 21, RAM (random access memory) 22, memory 23, an operation interface 24, a display 25, and a communicator 26. Those components are connected by a bus 27.

The CPU 21 comprehensively controls processing operation of components of the controller 20. The CPU 21 reads various processing programs stored in the memory 23 in response to operation signals input from the operation interface 24 or instruction signals received by the communicator 26. The CPU 21 develops the programs in the RAM 22 and cooperates with the programs to execute processing of various kinds.

For example, the CPU 21 cooperates with a RIP processing program 231 to analyze the print data (PDL data) received from the print instruction terminals 40a, 40b, etc. and to develop it into image data to be printed (CMYK values) in a bitmap format (RIP processing). The CPU 21 generates a list of jobs based on the print data received from the print instruction terminals 40a, 40b, etc. The CPU 21 sends the list to the color conversion table generation device 30. The CPU 21 transmits the image data to be printed, a device profile 233, and a device link profile 234 to the color conversion table generation device 30 in response to request from the color conversion table generation device 30.

The CPU 21 cooperates with the color conversion processing program 232 to perform color conversion on the image data to be printed using the modified device profile 233 or the device link profile 234 which is modified and received from the color conversion table generation device 30.

The RAM 22 forms a work area that temporarily stores various processing programs executed by the CPU 21 and data for these programs.

The memory 23 is constituted by non-volatile semiconductor memory or a storage device such as a hard disk. The memory 23 stores various processing programs, data related to processing of various kinds, received print data, and the like. For example, the memory 23 stores the RIP processing program 231, the color conversion processing program 232, the device profile 233, the device link profile 234, and the like. The device profile 233 and the device link profile 234 are color conversion tables used in color conversion processing. One or more device profiles 233 and device link profiles 234 are stored.

The device profile 233 relates device values (CMYK values, RGB values, etc.), which depend on devices such as printers and monitors, to color values (XYZ values, L*a*b* values, etc.) that do not depend on devices.

The device profile 233 is constituted by:

a color conversion table (LUT—look up table) from device values to color values; and

a color conversion table from color values to device values.

For example, the device profile 233 for a CMYK printer is constituted by:

an LUT from CMYK values to L*a*b* values (referred to as A to B table); and

an LUT from L*a*b* values to CMYK values (referred to as B to A table).

The color values form a color space that connects the profiles, and is called a profile connection space.

To perform the color conversion processing, the device profile 233 of a target device for color matching is required. It is called a source profile (target profile). For example, a profile of an offset printer or a standard profile such as Japan Color (registered trademark) is selected as the source profile.

The device profile 233 of an output device is called a destination profile (printer profile). A profile of the printer 10 that actually outputs data is selected as the destination profile.

Device values (CMYK values, RGB values, etc.) of input image data are converted into color values that do not depend on devices using an A to B table of a source profile. The color values are converted into device values (e.g. CMYK values) of an output device using a B to A table of a destination profile. CMYK values of the printer 10 which correspond to colors of a target device can be obtained through this conversion.

The device link profile 234 is an LUT that includes:

a color conversion table from device values of an input device to color values; and

a color conversion table from color values to device values of an output device.

Thus, the device link profile 234 is an LUT in which device values of an input device are related to device values of an output device. Since the device link profile 234 is used, color conversion can be done in one step. CMYK values do not have to be converted into three-dimensional L*a*b* values, etc. It reduces loss of information. For example, information of a key plate (K value) remains. However, it is not possible to obtain color values using only the device link profile 234.

The device link profile 234 consists of only one LUT. CMYK values of input image data are converted into CMYK values of an output device using the LUT of the device link profile 234.

The device profile 233 includes:

a source profile for converting image data to be printed (CMYK values) into color values which appear if the data were output in a target device;

a destination profile for converting color values into CMYK values of the printer 10; and

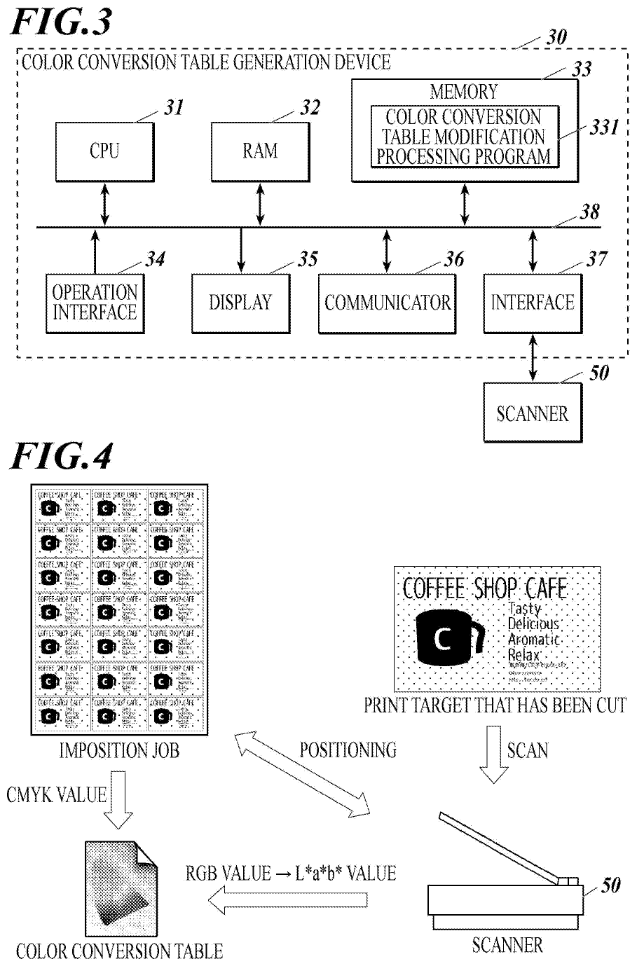

a scanner profile for converting read image data (RGB values) read by the scanner 50 (see FIG. 3) into color values.

The device link profile 234 for converting image data to be printed (CMYK values) into CMYK values of the printer 10 which correspond to colors of a target device is stored as the device link profile 234.

The operation interface 24 includes a keyboard equipped with cursor keys, letter keys, various function keys, etc. and a pointing device such as a mouse. The operation interface 24 accepts input by a user. The operation interface 24 outputs, to the CPU 21, operation signals input by key operation on the keyboard and mouse operation.

The display 25 includes an LCD (liquid crystal display) and displays various operation screens and various processing results in accordance with instructions from the CPU 21.

The communicator 26 transmits and receives data to/from external devices connected via the communication network N.

FIG. 3 shows a functional configuration of the color conversion table generation device 30. As shown in FIG. 3, the color conversion table generation device 30 includes a CPU 31, RAM 32, memory 33, an operation interface 34, a display 35, a communicator 36, and an interface 37. Those components are connected by a bus 38.

The CPU 31 comprehensively controls processing operation of components of the color conversion table generation device 30.

The CPU 31 reads various processing programs stored in the memory 33 according to:

operation signals input from the operation interface 34; or

instruction signals received by the communicator 36.

The CPU 31 develops the programs in the RAM 32. The CPU 31 cooperates with the programs to execute processing of various kinds.

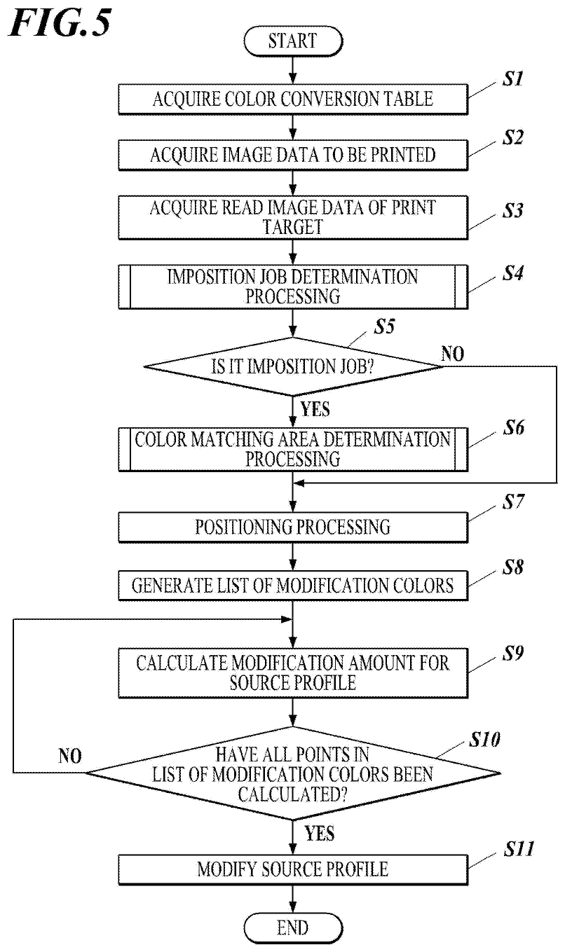

For example, the CPU 31 cooperates with a color conversion table modification processing program 331 to execute color conversion table modification processing (see FIG. 5), which will be described later. The CPU 31 obtains, from the controller 20, a color conversion table to be applied to image data to be printed in a selected job. The CPU 31 modifies the color conversion table and sends it to the controller 20.

The RAM 32 forms a work area that temporarily stores various processing programs executed by the CPU 31 and data for these programs.

The memory 33 is constituted by non-volatile semiconductor memory or a storage device such as a hard disk. The memory 33 stores various processing programs, data related to processing of various kinds, and the like. For example, the memory 33 stores the color conversion table modification processing program 331 and the like.

The operation interface 34 includes a keyboard equipped with cursor keys, letter keys, various function keys, etc. and a pointing device such as a mouse. The operation interface 34 accepts input by a user. The operation interface 34 outputs, to the CPU 31, operation signals input by key operation on the keyboard and mouse operation.

The operation interface 34 functions as a specification unit that specifies a target area to be used for modifying a color conversion table in a preview image of image data to be printed which is displayed on the display 35.

The operation interface 34 functions as an instruction unit which indicates that a print job for image data to be printed is an imposition job.

The display 35 includes an LCD and displays various operation screens and various processing results in accordance with instructions from the CPU 31. For example, the display 35 displays a graphical user interface (GUI) for modifying a color conversion table.

The communicator 36 transmits and receives data to/from external devices connected via the communication network N. For example, the communicator 36 transmits a color conversion table modified in the color conversion table generation device 30 to the controller 20.

The interface 37 receives image data (RGB values) obtained by reading a print target, which is a target for color matching, with the scanner 50.

The CPU 31 acquires a color conversion table used for color conversion of image data to be printed. Thus, the CPU 31 functions as a color conversion table acquisition unit. Image data to be printed may be imposed. Imposition means arranging images such that multiple images are printed on a single sheet.

The CPU 31 acquires image data to be printed. Thus, the CPU 31 functions as an image data acquisition unit.

The CPU 31 acquires read image data of a print target (color sample) corresponding to a partial or a whole area in image data to be printed. Thus, the CPU 31 functions as a read image data acquisition unit. In a case of imposed image data to be printed, the print target corresponds to a partial area in the image data to be printed.

The CPU 31 accepts specification of a target area in image data to be printed which is used for modifying a color conversion table. Thus, the CPU 31 functions as an acceptance unit.

Specifically, the CPU 31 displays a preview image of image data to be printed on the display 35. The CPU 31 accepts specification of a target area from the operation interface 34.

The CPU 31 displays a specification frame of a size of read image data of a print target in a preview image. The CPU 31 places the specification frame at the target area by moving the specification frame in response to a user's operation via the operation interface 34. Thus, the CPU 31 accepts specification of the target area.

In a case where it is instructed that a print job for image data to be printed is an imposition job, the CPU 31 displays a specification frame of a size of read image data of a print target in a preview image.

The CPU 31 extracts a feature amount from image data to be printed. The CPU 31 determines whether a similar pattern is repeated based on the extracted feature amount. Thus, the CPU 31 functions as a determination unit. Similar patterns are image areas that are mutually similar (similarity based on the feature amount exceeds a threshold).

In a case where the CPU 31 determines that the similar pattern is repeated, the CPU 31 displays a specification frame of a size of read image data of a print target in a preview image. The CPU 31 displays the specification frame such that the frame is placed at one of the similar patterns in the preview image.

The CPU 31 modifies a color conversion table based on:

information (CMYK values) corresponding to a specified target area in image data to be printed; and

read image data (RGB values) of a print target.

Thus, the CPU 31 functions as a modification unit.

FIG. 4 is an image showing modification of a color conversion table based on a cut print target and image data to be printed in an imposition job. The print target is a printed sheet that includes an image area corresponding to a partial area of the image data to be printed. In this example, coffee shop tickets are printed. In the example of FIG. 4, twenty one ticket images are imposed in the image data to be printed.

First, read image data (RGB values) is obtained by reading a cut print target with the scanner 50. A position of the read image data (RGB values) of the print target is matched with a position of the image data (CMYK values) to be printed in the imposition job. Specifically, in the image data to be printed, a target area which is to be used for modification is determined. Correspondence in coordinates between the target area and the read image data is obtained.

Next, target color values (L*a*b* values) are determined based on the read image data (RGB values) of the print target using the scanner profile. Theoretical L*a*b* values obtained with the current source profile are calculated from information (CMYK values) of the target area of the image data to be printed in the imposition job. An amount of modification for a color conversion table is obtained from a difference between them.

Next, operation in the first embodiment will be described.

FIG. 5 is a flowchart showing a color conversion table modification processing executed in the color conversion table generation device 30. The color conversion table modification processing modifies, based on colors of a print target, a color conversion table (device profile 233 or device link profile 234) used for color conversion of image data to be printed.

In the color conversion table generation device 30, a job is selected from a job list by the operation interface 34. Modification of a color conversion table used for color conversion is instructed in the job. The color conversion table modification processing is realized by software processing by the CPU 31 in cooperation with the color conversion table modification processing program 331 stored in the memory 33.

In the example of FIG. 5, the device profile 233 is used as the color conversion table.

First, the CPU 31 acquires the color conversion table (device profile 233) used for color conversion of image data to be printed in a selected job from the controller 20 via the communicator 36 (Step S1).

In Step S1, the CPU 31 obtains, from the controller 20, (i) a source profile for converting the image data to be printed (CMYK values) into color values and (ii) a destination profile for converting color values into CMYK values for the printer 10 that performs printing. Further, the CPU 31 obtains, from the controller 20, a scanner profile for converting the image data (RGB values) read by the scanner 50 into color values. The CPU 31 may acquire the scanner profile from the memory 33 in a case where the scanner profile is stored in the memory 33 of the color conversion table generation device 30.

Next, the CPU 31 acquires the image data to be printed in the selected job from the controller 20 via the communicator 36 (Step S2).

The color conversion table generation device 30 may include the RIP processing program. In that case, the CPU 31 receives print data (PDF data or TIFF data) from the controller 20. After the color conversion table generation device 30 performs RIP processing, the CPU 31 acquires the image data to be printed.

Next, the CPU 31 acquires read image data of a print target, which is a target for color matching (Step S3).

Specifically, the read image data is obtained by reading the print target with the scanner 50 in response to user operation. The CPU 31 receives the read image data via the interface 37. The read image data may be acquired using a digital camera instead of the scanner 50.

Next, the CPU 31 performs imposition job determination processing (Step S4). The imposition job determination processing determines whether a print job for image data is an imposition job.

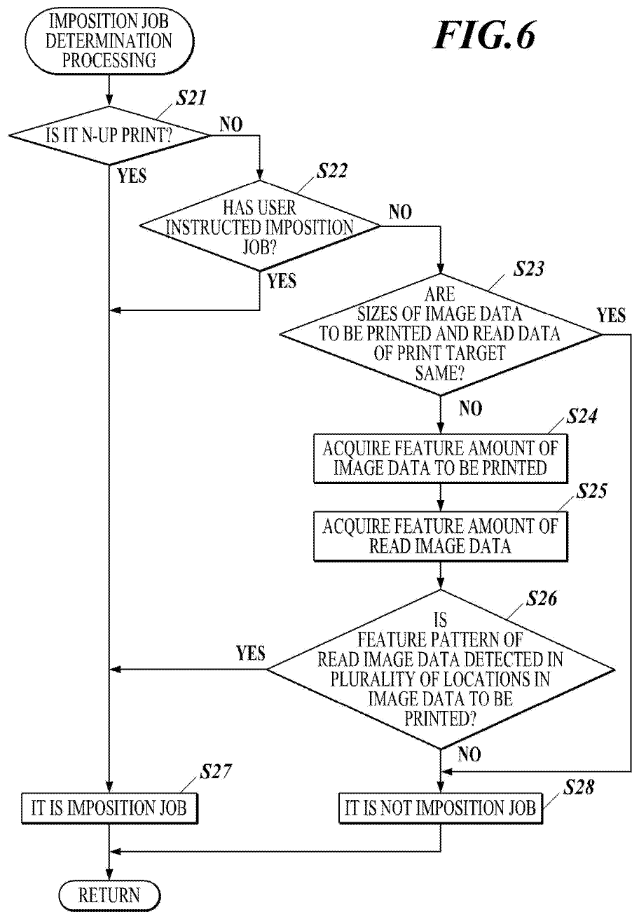

The imposition job determination processing will be described with reference to FIG. 6.

The CPU 31 determines whether a print job for the image data to be printed is N-up print (Step S21). In N-up print, N images are evenly allocated on a single sheet. The fact that it is N-up print is described in setting information of a print job. The CPU 31 obtains the setting information of the print job from the controller 20 to determine whether the print job is N-up print.

In a case where a print job for image data is N-up print (YES in Step S21), the CPU 31 determines that the print job for the image data is an imposition job (Step S27).

In a case where a print job for image data is not N-up print in Step S21 (NO in Step S21), the CPU 31 determines whether a user has instructed an imposition job (Step S22). Specifically, the CPU 31 displays a screen for explicitly indicating that it is an imposition job on the display 35. The CPU 31 waits for a user's instruction via the operation interface 34.

In a case where a user has instructed an imposition job (YES in Step S22), the CPU 31 determines that the print job for the image data is an imposition job (Step S27).

In a case where a user has not instructed an imposition job in Step S22 (NO in Step S22), the CPU 31 determines whether a size of the image data to be printed which is obtained in Step S2 and a size of the read image data of the print target which is obtained in Step S3 are the same (Step S23).

In a case where the size of the image data to be printed and the size of the read image data of the print target are the same (YES in Step S23), the CPU 31 determines that the print job for the image data to be printed is not an imposition job (Step S28).

In a case where the sizes of the image data to be printed and the read image data of the print target are different in Step S23 (NO in Step S23), the CPU 31 acquires a feature amount of the image data to be printed (Step S24). For example, a difference in luminance between adjacent pixels is used as the feature amount. Alternatively, a point where a difference in luminance is large is extracted as an edge, and a position of the edge is used as the feature amount.

Next, the CPU 31 acquires a feature amount of the read image data of the print target (Step S25). A difference in luminance between adjacent pixels, a position of an edge, or the like is acquired as a feature amount of the read image data.

Next, the CPU 31 compares the feature amount of the image data to be printed with the feature amount of the read image data of the print target. The CPU 31 determines whether a feature pattern of the read image data is detected at a plurality of locations in the image data to be printed (Step S26). A fact that the feature pattern of the read image data exists at a plurality of locations in the image data to be printed means that a pattern similar to the feature pattern of the read image data is repeated in the image data to be printed. Each area that is determined to have a similar pattern may include a portion different from other areas (such as a variable portion in variable printing).

In a case where a feature pattern of the read image data is detected at a plurality of locations in the image data to be printed (YES in Step S26), that is, a similar pattern is repeated in the image data to be printed, the CPU 31 determines that the print job for the image data to be printed is an imposition job (Step S27).

In a case where a feature pattern of the read image data is not detected at a plurality of locations in the image data to be printed in Step S26 (NO in Step S26), the CPU 31 determines that the print job for the image data to be printed is not an imposition job (Step S28).

After Step S27 or Step S28, the imposition job determination processing ends.

In FIG. 5, in a case where the print job for the image data is determined to be an imposition job (YES in Step S5) as a result of the imposition job determination processing (Step S4), the CPU 31 performs color matching area determination processing (Step S6). The color matching area determination processing determines which area in the image data to be printed in the imposition job corresponds to the read image data of the print target. The CPU 31 may allow a user to specify a target area (color matching area) to be used for modifying a color conversion table in the image data to be printed. Alternatively, the CPU 31 may extract a target area from the image data to be printed by image processing. In a case where a target area is automatically extracted, it is desirable to add a step in which the area is shown to a user for confirmation.

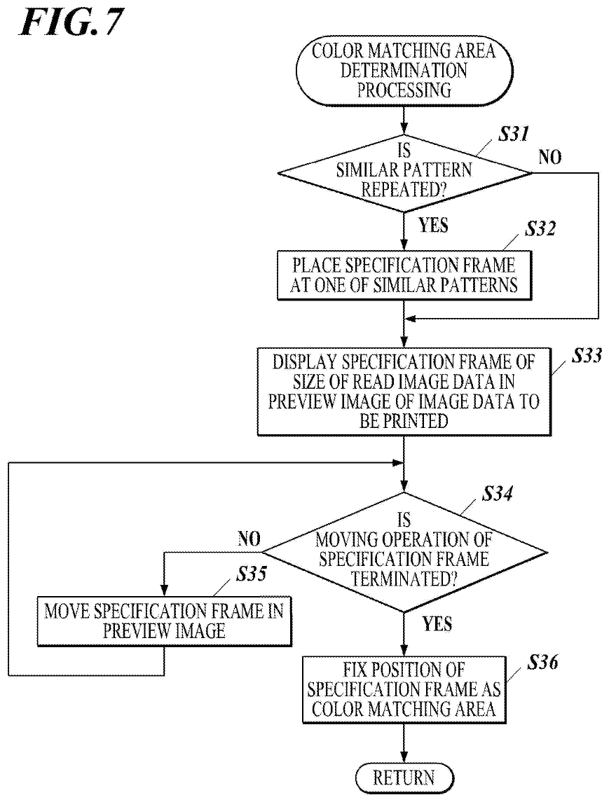

The color matching area determination processing will be described with reference to FIG. 7.

The CPU 31 determines whether it is determined that it is an imposition job as a result of determination that a similar pattern is repeated in image data to be printed (Step S31).

In a case where it is determined that it is an imposition job as a result of determination that a similar pattern is repeated in the image data to be printed (YES in Step S31), the CPU 31 places a specification frame at one of similar patterns in the image data to be printed (Step S32).

After Step S32, or in Step S31, in a case where the job is determined to be an imposition job for a reason other than determination that a similar pattern is repeated in the image data to be printed (NO in Step S31), the CPU 31 displays a preview image of the image data to be printed on the display 35. The CPU 31 displays a specification frame of a size of the read image data of the print target in the preview image (Step S33).

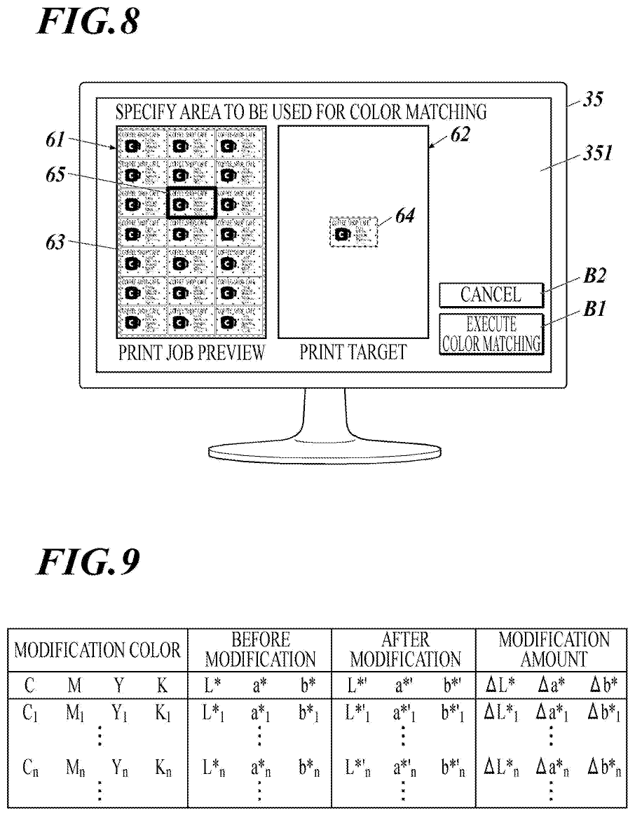

FIG. 8 shows an example of a color matching area specification screen 351 displayed on the display 35. The color matching area specification screen 351 includes a print job preview display area 61, a print target display area 62, a color matching execution button B1, and a cancel button B2.

A preview image 63 based on image data to be printed is displayed in the print job preview display area 61.

An image 64 based on read image data of a print target is displayed in the print target display area 62.

The color matching execution button B1 is a button for instructing execution of color matching.

The cancel button B2 is a button for canceling area specification in the color matching area specification screen 351.

A specification frame 65 of a size of the read image data of the print target is displayed in the preview image 63 of the image data to be printed. In a case where a similar pattern is repeated in the image data to be printed, the specification frame 65 is displayed such that it is placed at one of similar patterns. In the example of FIG. 8, the specification frame 65 is placed at an area corresponding to one ticket.

On the color matching area specification screen 351, specification of a color matching area in the preview image 63 of the image data to be printed by the operation interface 34 is accepted. Specifically, a user operates the operation interface 34. The user puts a mouse pointer on the specification frame 65 in the preview image 63. In that state, the user moves the specification frame 65 by dragging the mouse pointer. The user can change a size of the specification frame 65 by changing a length of the specification frame 65 in a vertical or horizontal direction while the specification frame 65 is selected.

Next, the CPU 31 waits for instruction from a user through the operation interface 34, and then determines whether operation to terminate moving operation of the specification frame is performed (Step S34). For example, in a case where the color matching execution button B1 in the color matching area specification screen 351 is pressed, the CPU 31 determines that operation for terminating moving operation of the specification frame is performed.

In a case where operation to terminate moving operation of the specification frame is not performed (NO in Step S34), the CPU 31 moves the specification frame in the preview image of the image data to be printed in response to a user's operation on the operation interface 34 (Step S35).

Then, processing from Step S34 is repeated.

In a case where operation to terminate moving operation of the specification frame is performed in Step S34 (YES in Step S34), that is, an area in the preview image which corresponds to the print target is specified, the CPU 31 determines the position of the current specification frame as a color matching area (target area) (Step S36). The color matching area determination processing is thus completed.

In FIG. 5, the CPU 31 performs positioning processing (Step S7) (i) after the color matching area determination processing (Step S6) or (ii) in a case where the print job for the image data to be printed is determined not to be an imposition job as a result of the imposition job determination processing in Step 5 (NO in Step S5).

In the case where the print job for the image data is an imposition job, the CPU 31 finds correspondence between:

coordinates of the determined color matching area (target area) in the image data to be printed; and

coordinates of an area of the read image data of the print target.

For example, the CPU 31 relates coordinates of images with each other based on feature amounts of the image data. Alternatively, the CPU 31 may perform a tilt correction or the like on the read image data and then obtain correspondence between coordinates by adding the number of pixels in the corrected read image data and the number of pixels in the color matching area of the image data to be printed.

In the case where the print job for the image data is not an imposition job, the CPU 31 finds correspondence between:

coordinates of an entire image area of the image data to be printed; and

coordinates of an area of the read image data of the print target.

Next, the CPU 31 generates a list of modification colors for modifying a color conversion table (Step S8).

Specifically, the CPU 31 extracts modification colors (CMYK values) to be used for color conversion from:

a fixed color matching area in the image data to be printed (in the case of imposition job); or

an entire image area of the image data to be printed (in the case of not an imposition job).

The CPU 31 lists the modification colors. Selecting all the used colors as modification colors is not practical in terms of computational complexity. In modification of the color conversion table, each color has a certain range. The number of modification colors is determined based on a modification amount. For example, colors within a range of a modification amount are considered to be the same colors. For example, colors are clustered by the k-means clustering, etc. Colors of the number of colors classified by clustering is extracted. The number of colors may be limited to some extent. For example, a color matching area or an entire image area is divided into 3 mm square areas. A color in each area is extracted. Similar colors are thinned out from colors extracted from the areas.

Next, the CPU 31 calculates a modification amount in a source profile for a certain color in the modification color list (Step S9).

To match modification colors in the modification color list to colors of the print target, the source profile is modified such that color values of the modification colors in the source file match color values of colors in the print target which correspond to the modification colors.

In Step S9, for each modification color in the modification color list, the CPU 31 calculates, as a modification amount of a color value corresponding to the modification color in the source profile, a difference between:

a value obtained by converting a value (device value) of the image data to be printed into a color value using the source profile; and

a value obtained by converting a value (RGB value) of the read image data of the print target into a color value using the scanner profile.

Not only the modification color, but also colors in a certain range around it may be modified. This is preferable because it reduces occurrence of tone jumps.

FIG. 9 shows data structure of modification amounts for a source profile. As shown in FIG. 9, modification amounts ΔL*, Δa*, Δb* are obtained by following Equation (I). L*, a*, and b* are color values of each modification color in the source profile before modification. L*′, a′, and b*′ are color values after modification based on a print target.

ΔL*=L*′−L*

Δa*=a*′−a* Equation (I)

Δb*=b*′−b*

Next, the CPU 31 determines whether modification amounts for all points (modification colors) in the modification color list have been calculated (Step S10).

In a case where one or more modification colors listed in the modification color list have not been calculated (NO in Step S10), processing from Step S9 is repeated for another modification color.

In a case where modification amounts for all points in the modification color list have been calculated (YES in Step S10), the CPU 31 modifies the source profile based on the calculated modification amounts (Step S11). The CPU 31 ends the color conversion table modification processing.

In Step S11, the CPU 31 modifies the source profile by adding a modification amount to a color value in the source profile which corresponds to a modification color. For colors (grids) that are affected by modification of multiple points (modification colors), it is desirable to, for example, average modification amounts. It prevents modification of more than an expected amount. The source profile may be modified by smoothing calculation. For example, an average movement of all points is calculated.

An example in which a device profile 233 (source profile) is modified is described above. Substantially the same processing can be performed in modification of the device link profile 234.

To modify the device link profile 234, first, color values L*, a*, b* before modification of the modification colors are converted into device values C, M, Y, K of the printer 10 using a destination profile. Similarly, color values L*′, a′, b*′ of a print target which correspond to the modification colors are converted into device values C′, M′, Y′, K′ of the printer 10 using the destination profile. Differences ΔC, ΔM, ΔY, ΔK between C′, M′, Y′, K′ and C, M, Y, K are then added to CMYK values (output values) corresponding to the modification colors in the device link profile 234. Thereby, conversion information of the modification colors in the device link profile 234 is modified in accordance with the print target.

After the color conversion table modification processing, the CPU 31 relates the modified device profile 233 or the device link profile 234 to a job ID. The CPU 31 transmits it to the controller 20 via the communicator 36. To convert colors in the job of the received job ID, the CPU 21 of the controller 20 performs color conversion processing using the device profile 233 or the modified device profile 233. Thereby, colors of the output device (printer 10) are matched with colors of the print target.

As explained above, according to the first embodiment, a color conversion table used for color conversion of image data to be printed is modified based on imposed image data to be printed and read image data of a print target. Specification of a target area in the image data to be printed which is to be used for modifying the color conversion table is accepted. Accordingly, even in a case where a cut print target is used in color conversion to match colors of a print result of image data to be printed with colors of a print target, correspondence between the print target and a partial area in the image data to be printed is easily obtained. Colors are easily matched.

A preview image of the image data to be printed is displayed on the display 35. The operation interface 34 accepts specification of a target area. Accordingly, a user can visually confirm an area in the image data to be printed which corresponds to the print target. It reduces risk of failure in positioning.

A frame of a size of the read image data of the print target is displayed in the preview image. Therefore, a user can specify a target area by moving the specification frame. Effort in a user's operation is less as compared with a case where, for example, two points (upper left, lower right, etc.) indicating a diagonal are specified to specify a rectangular area.

In a case where the operation interface 34 indicates that a print job for image data to be printed is an imposition job, a specification frame can be displayed in a preview image.

In a case where it is determined that a similar pattern is repeated in image data to be printed, a specification frame can be displayed in a preview image.

The specification frame is displayed such that the frame is placed at one of the similar patterns in the preview image. Therefore, if there is no problem with a position of the specification frame, the specification frame can be fixed as a target area which is to be used for modifying a color conversion table.

### Second Embodiment

Next, a second embodiment of the present invention will be described.

A configuration of a print system according to the second embodiment is similar to that of the print system 100 according to the first embodiment. See FIG. 1 to FIG. 3 for the similar configuration. Figures and descriptions are omitted. Configurations and processing characteristic of the second embodiment will be described below.

The CPU 31 of the color conversion table generation device 30 extracts a feature amount from image data to be printed. Based on the extracted feature amount, the CPU 31 determines whether a similar pattern is repeated. Thus, the CPU 31 functions as the determination unit. Specifically, the CPU 31 determines whether a similar pattern is repeated based on a size of read image data of a print target as one unit.

In a case where the CPU 31 determines that a similar pattern is repeated, the CPU 31 displays a specification frame of the size of the read image data of the print target in a preview image. The CPU 31 displays the specification frame such that the frame is placed at one of the similar patterns in the preview image.

If a feature amount of a similar pattern extracted from the image data to be printed does not match a feature amount of the read image data of the print target, the CPU 31 informs it. Thus, the CPU 31 functions as an informing unit. Whether a feature amount of a similar pattern match a feature amount of read image data is determined based on, for example, whether similarity between the feature amount of the similar pattern and the feature amount of the read image data exceeds a threshold value. In a case where the similarity between the feature amounts is less than a threshold value, the CPU 31 determines that the feature amounts do not match.

Next, operation in the second embodiment will be described.

In the second embodiment, processing like the color conversion table modification processing in FIG. 5 is performed. Instead of the imposition job determination processing (see FIG. 6) in Step S4, second imposition job determination processing is performed. The color matching area determination processing in Step S6 (see FIG. 7) is similar to that in the first embodiment.

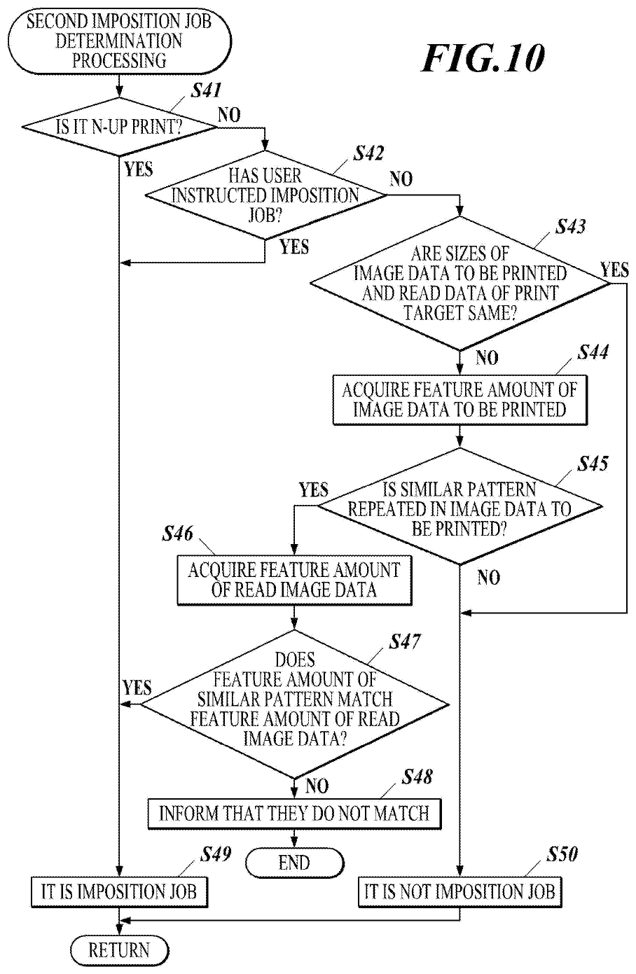

FIG. 10 is a flowchart showing the second imposition job determination processing.

Processing of Steps S41-S44 in the second imposition job determination processing is the same as processing of Steps S21-S24 in the imposition job determination processing. Explanation is omitted.

After Step S44, the CPU 31 determines, based on a feature amount of image data to be printed, whether a similar pattern having a size of read image data of a print target is repeated in the image data to be printed (Step S45).

In a case where the CPU 31 determines that a similar pattern having the size of the read image data of the print target is repeated in the image data to be printed (YES in Step S45), the CPU 31 acquires a feature amount of the read image data of the print target (Step S46).

Next, the CPU 31 determines whether the feature amount of the similar pattern matches the feature amount of the read image data of the print target (Step S47).

In a case where the feature amount of the similar pattern matches the feature amount of the read image data of the print target (YES in Step S47), the CPU 31 determines that a print job for the image data is an imposition job (Step S49).

In a case where the feature amount of the similar pattern does not match the feature amount of the read image data of the print target in Step S47 (NO in Step S47), the CPU 31 informs a determination result that the feature amount of the similar pattern in the image data to be printed does not match the feature amount of the read image data of the print target (Step S48). Specifically, the CPU 31 displays, on the display 35, a message that the feature amount of the similar pattern does not match the feature amount of the read image data.

After Step S48, the color conversion table modification processing in the second embodiment is completed (or suspended). Alternatively, processing may proceed to Step S49 or Step S50 after the CPU 31 urges a user to determine whether it is an imposition job.

In a case where the print job for the image data is an N-up print in Step S41 (YES in Step S41) and a user has instructed an imposition job in Step S42 (YES in Step S42), the CPU 31 determines that the print job for the image data to be printed is an imposition job (Step S49).

In a case where it is determined in Step S43 that sizes of the image data to be printed and the read image data of the print target are the same (YES in Step S43) and where it is determined in Step S45 that a similar pattern having the size of the read image data of the print target is not repeated in the image data to be printed (NO in Step S45), the CPU 31 determines that the print job for the image data is not an imposition job (Step S50).

After Step S49 or Step S50, the second imposition job determination processing ends.

As described above, like the first embodiment, according to the second embodiment, even in a case where a cut print target is used in color conversion to match colors of a print result of image data to be printed with colors of a print target, correspondence between the print target and a partial area in the image data to be printed is easily obtained. Colors are easily matched.

Whether a similar pattern is repeated in image data to be printed is determined based on a size of read image data of a print target as one unit. Therefore, a similar pattern is detected efficiently.

In a case where it is determined that a similar pattern is repeated in image data to be printed, a specification frame of a size of read image data of a print target can be displayed in a preview image.

The specification frame is displayed such that the frame is placed at one of the similar patterns in the preview image. Therefore, if there is no problem with a position of the specification frame, the specification frame can be fixed as a target area which is to be used for modifying a color conversion table.

If a feature amount of a similar pattern extracted from image data to be printed does not match a feature amount of read image data of a target print, it will be informed. It can urge user to check the data.

The above embodiments are examples of a color conversion table generation device according to the present invention. The device is not limited to those examples. Configurations of details and operation of components constituting the device can be changed within the scope of the claims.

For example, in the above embodiments, the controller 20 uses a color conversion table that has been modified by the color conversion table generation device 30. Alternatively, the printer 10 may use a color conversion table that has been modified by the color conversion table generation device 30.

All of the criteria for determining whether a print job for image data to be printed is an imposition job may not be included in:

the imposition job determination processing according to the first embodiment (see FIG. 6); and

the second imposition job determination processing according to the second embodiment (see FIG. 10).

For example, the imposition job determination processing may not include determination of Steps S21-S22. In the imposition job determination processing, whether a job is an imposition job may be determined based solely on determination of Step S22.

In the above example, non-volatile semiconductor memory or a hard disk is used as a computer-readable medium that stores programs for executing the processing. The medium is not limited to those examples. A portable recording medium such as CD-ROM can also be applied as a computer-readable medium. A carrier wave may be applied as a medium that provides program data through a communication line.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese patent application No. 2020-199968, filed on Dec. 2, 2020, is incorporated herein by reference in its entirety.

What is claimed is:

1. A color conversion table generation device, comprising:
a color conversion table acquisition unit that acquires a color conversion table used in color conversion for image data to be printed which is imposed;
an image data acquisition unit that acquires the image data to be printed;
a read image data acquisition unit that acquires read image data of a print target corresponding to a partial area in the image data to be printed;
an acceptance unit that accepts specification of a target area in the image data to be printed which is to be used for modifying the color conversion table; and
a modification unit that modifies the color conversion table based on the read image data and information corresponding to the specified target area in the image data to be printed.

2. The color conversion table generation device according to claim 1, further comprising:
a display that displays a preview image of the image data to be printed; and
a specification unit that specifies the target area in the preview image displayed on the display,
wherein the acceptance unit accepts specification of the target area from the specification unit.

3. A color conversion table generation device according to claim 2, wherein
the acceptance unit accepts the specification of the target area by:
displaying a specification frame of a size of the read image data of the print target in the preview image; and
placing the specification frame at the target area by moving the specification frame in response to a user's operation on the specification unit.

4. The color conversion table generation device according to claim 3, further comprising:
an instruction unit that instructs that a print job for the image data to be printed is an imposition job,
wherein, in a case where the instruction unit instructs that a print job for image data to be printed is an imposition job, the acceptance unit displays the specification frame in the preview image.

5. The color conversion table generation device according to claim 3, further comprising:
a determination unit which extracts a feature amount from the image data to be printed and which determines whether a similar pattern is repeated based on the extracted feature amount,
wherein, in a case where the determination unit determines that the similar pattern is repeated, the acceptance unit displays the specification frame in the preview image.

6. A color conversion table generation device according to claim 5, wherein the determination unit determines whether the similar pattern is repeated based on a size of the read image data of the print target as one unit.

7. A color conversion table generation device according to claim 5, wherein, in a case where the determination unit determines that the similar pattern is repeated, the acceptance unit displays the specification frame such that the frame is placed at one of the similar patterns in the preview image.

8. The color conversion table generation device according to claim 5, further comprising:
an informing unit that informs that the feature amount of the similar pattern does not match a feature amount of the read image data of the print target.

9. A non-transitory recording medium storing a computer readable program that causes a computer to function as:
a color conversion table acquisition unit that acquires a color conversion table used in color conversion for image data to be printed which is imposed;
an image data acquisition unit that acquires the image data to be printed;
a read image data acquisition unit that acquires read image data of a print target corresponding to a partial area in the image data to be printed;
an acceptance unit that accepts specification of a target area in the image data to be printed which is to be used for modifying the color conversion table; and
a modification unit that modifies the color conversion table based on the read image data and information corresponding to the specified target area in the image data to be printed.
